(19) United States
(12) Patent Application Publication
(10) Pub. No.: US 2026/0361177 A1
(43) Pub. Date: Nov. 12, 2026

(54) ROTATIONAL BALANCE CORRECTION METHOD

(71) Applicant: MITSUBA Corporation, Gunma (JP)

(72) Inventors: YUTARO JO, Gunma (JP); YUTA AOKI, Gunma (JP); YUSUKE FUKUSHIMA, Gunma (JP); HARUTO SATO, Gunma (JP); HITOSHI OIKAWA, Gunma (JP); KOSUKE MATSUSHIMA, Gunma (JP)

(73) Assignee: MITSUBA Corporation, Gunma (JP)

(21) Appl. No.: 19/667,618

(22) Filed: May 4, 2026

(30) Foreign Application Priority Data
May 12, 2025 (JP) 2025-079914

(51) Int. Cl. H02K 7/04; H02K 11/20

(52) U.S. Cl. CPC H02K 7/04; H02K 11/20; H02K 2211/00

(57) ABSTRACT

Provided is a rotational balance correction method capable of accurately correcting rotational balance even in the case where the cutting depth of a cut portion is deep. A first balance measuring device 102 executes the process of step S3 of rotating a workpiece W to seek a balance correction amount B and specifying a position (correction position) of an unbalanced portion UB of a weight 40 in the circumferential direction. Further, a cutting device 103 executes the process of step S8 of using a calculation formula (polynomial) stored in advance, controlling a rotary cutting blade 103e to achieve a cutting depth R obtained by substituting the balance correction amount B into the calculation formula, and cutting the unbalanced portion UB of the weight 40. The above calculation formula is a formula that takes into account changes in the cutting depth R of the cut portion, and is capable of accurately correcting the rotational balance of the workpiece W even in the case where the cutting depth R of the cut portion is deep.

### CROSS-REFERENCE TO RELATED APPLICATION

This application claims the priority benefit of Japanese Application Serial No. 2025-079914, filed on May 12, 2025. The entirety of the above-mentioned patent application is hereby incorporated by reference herein and made a part of this specification.

### TECHNICAL FIELD

The disclosure relates to a rotational balance correction method for correcting the rotational balance of a rotor.

### BACKGROUND ART

Patent Document 1 (Japanese Patent Application Laid-Open No. 2019-045184) describes a rotating body for a brushed motor including a rotation shaft, a core around which a coil is wound, and a commutator. In the technology described in Patent Document 1, the outer peripheral portion of the core fixed to the rotation shaft is cut in order to correct the rotational balance of the rotating body.

Further, Patent Document 2 (Japanese Patent Application Laid-Open No. 2024-172575) describes a rotor for a brushless motor including a rotation shaft, a rotor core, and a magnet. In the technology described in Patent Document 2, the outer peripheral portion of the rotor cannot be cut to correct the rotational balance of the rotor, and therefore, an adjustment member is fixed to the rotation shaft and the outer peripheral portion of the adjustment member is cut.

In the technology described in Patent Document 1, in order to correct the rotational balance of the rotating body, the unbalanced portion can be eliminated by cutting a relatively wide range of the outer peripheral portion of the core shallowly. On the other hand, in the technology described in Patent Document 2, the adjustment member smaller than the core described in Patent Document 1 needs to be cut. For this reason, it is required to increase the cutting depth in the radial direction of the adjustment member to eliminate the unbalanced portion.

The disclosure provides a rotational balance correction method capable of accurately correcting rotational balance even in the case where the cutting depth of a cut portion is deep.

### SUMMARY

According to one aspect of the disclosure, a rotational balance correction method for correcting rotational balance of a rotor is provided, wherein the rotor includes: a shaft; a rotor core provided on the shaft; a magnet provided on the rotor core; and a weight provided on the shaft and arranged coaxially with the rotor core, wherein a measuring device measuring rotational balance of the rotor, and a correction device correcting rotational balance of the rotor by cutting the weight are used, wherein the measuring device executes a rotational balance measurement step of rotating the rotor, and in the case where there is an unbalanced portion with a mass M having a center of gravity at a position at a distance r from a rotation center of the rotor in a radial direction of the weight, seeking a balance correction amount B indicated by a product of the distance r and the mass M, and specifying a position of the unbalanced portion in a circumferential direction of the weight, wherein the correction device executes a rotational balance correction step of using a calculation formula for obtaining a cutting depth R along the radial direction of the weight from the balance correction amount B to control a cutting tool so as to achieve the cutting depth R obtained by substituting the balance correction amount B into the calculation formula, and cutting the unbalanced portion of the weight, and wherein the calculation formula is a polynomial sought by a computer through the following procedures (1) to (9):
(1) prepare a 3D model of the weight and the cutting tool,
(2) arrange the cutting tool on the 3D model so as to achieve the cutting depth R from a radially outer side of the weight,
(3) seek a volume V of a cut portion to be cut by the cutting tool,
(4) seek a mass M of the cut portion by multiplying the volume V by a specific gravity d of the weight,
(5) prepare at least three different distances r1, r2, and r3 (r1<r2<r3) as a distance r from a rotation center of the weight to a center of gravity of the cut portion,
(6) seek balance correction amounts B1=M×r1, B2=M×r2, and B3=M×r3 respectively according to the distances r1, r2, and r3, create at least three graphs with the balance correction amounts B1, B2, and B3 on an x-axis and the cutting depth R on a y-axis, and plot the balance correction amounts B1, B2, and B3 and the cutting depth R respectively on the graphs,
(7) repeat (3) to (6) by changing the cutting depth R, and plot the balance correction amounts B1, B2, and B3 and the cutting depth R respectively on the graphs,
(8) determine areas in which plotted data is used according to the cutting depth R or the balance correction amount B, use plot data of the balance correction amount B3 and the cutting depth R in an area where the cutting depth R or the balance correction amount B is small, use plot data of the balance correction amount B2 and the cutting depth R in an area where the cutting depth R or the balance correction amount B is intermediate, use plot data of the balance correction amount B1 and the cutting depth R in an area where the cutting depth R or the balance correction amount B is large, and consolidate the plot data on one graph, and
(9) seek a polynomial indicating an approximation curve passing near the plot data consolidated on one graph.

According to another aspect of the disclosure, a rotational balance correction method for correcting rotational balance of a rotor is provided, wherein the rotor includes: a shaft; a rotor core provided on the shaft; a magnet provided on the rotor core; and a weight provided on the shaft and arranged coaxially with the rotor core, wherein a measuring device measuring rotational balance of the rotor, and a correction device correcting rotational balance of the rotor by cutting the weight are used, wherein the measuring device executes a rotational balance measurement step of rotating the rotor, and in the case where there is an unbalanced portion with a mass M having a center of gravity at a position at a distance r from a rotation center of the rotor in a radial direction of the weight, seeking a balance correction amount B indicated by a product of the distance r and the mass M, and specifying a position of the unbalanced portion in a circumferential direction of the weight, wherein the correction device executes a rotational balance correction step of using a calculation formula for obtaining a cutting depth R along the radial direction of the weight from the balance correction amount B to control a cutting tool so as to achieve the cutting depth R obtained by substituting the balance correction amount B into the calculation formula, and cutting the unbalanced portion of the weight, and wherein in the case where the balance correction amount B is taken as x and the cutting depth R is taken as y, the calculation formula is indicated by: a polynomial y=−5.5798x⁶+26.238x⁵−48.172x⁴+44.134x³−21.789x²+7.0366x+0.0796.

According to the disclosure, it is possible to realize a rotational balance correction method capable of accurately correcting rotational balance even in the case where the cutting depth of a cut portion is deep.

### BRIEF DESCRIPTION OF THE DRAWINGS

FIG. 1 is a cross-sectional view of a motor device along the axial direction of a rotor.

FIG. 2 is a perspective view of the rotor as seen from the worm side.

FIG. 3 is a perspective view of the rotor as seen from the rotor core side.

FIG. 4 is a view taken in the direction of arrow A in FIG. 2.

FIG. 5 is a view taken in the direction of arrow B in FIG. 3.

FIG. 6 is a schematic diagram showing a part of an assembly line of the rotor.

FIG. 7 is a perspective view showing a first balance measuring device.

FIG. 8 is a view for illustrating the operation of a preceding stage of a cutting device.

FIG. 9 is a view for illustrating the operation of a subsequent stage of the cutting device.

FIG. 10 is a flowchart showing the flow of a rotational balance correction work.

FIG. 11 is a diagram showing a 3D model of a weight and a rotary cutting blade.

FIG. 12 is a graph showing plot data in the case where the distance from the rotation center of the weight to the center of gravity of a cut portion is r3.

FIG. 13 is a graph showing plot data in the case where the distance from the rotation center of the weight to the center of gravity of the cut portion is r2 (r2<r3).

FIG. 14 is a graph showing plot data in the case where the distance from the rotation center of the weight to the center of gravity of the cut portion is r1 (r1<r2).

FIG. 15 is a graph showing an approximation curve synthesized from areas with small errors relative to measured values of the plot data in FIG. 12, FIG. 13, and FIG. 14.

### DESCRIPTION OF THE EMBODIMENTS

Hereinafter, an embodiment of the disclosure will be described in detail with reference to the drawings.

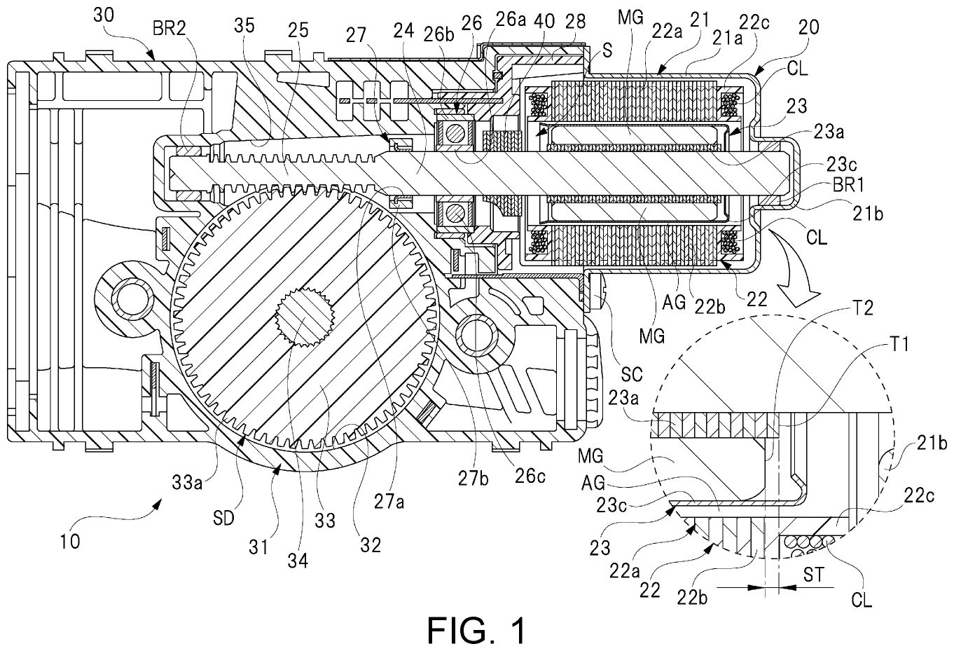

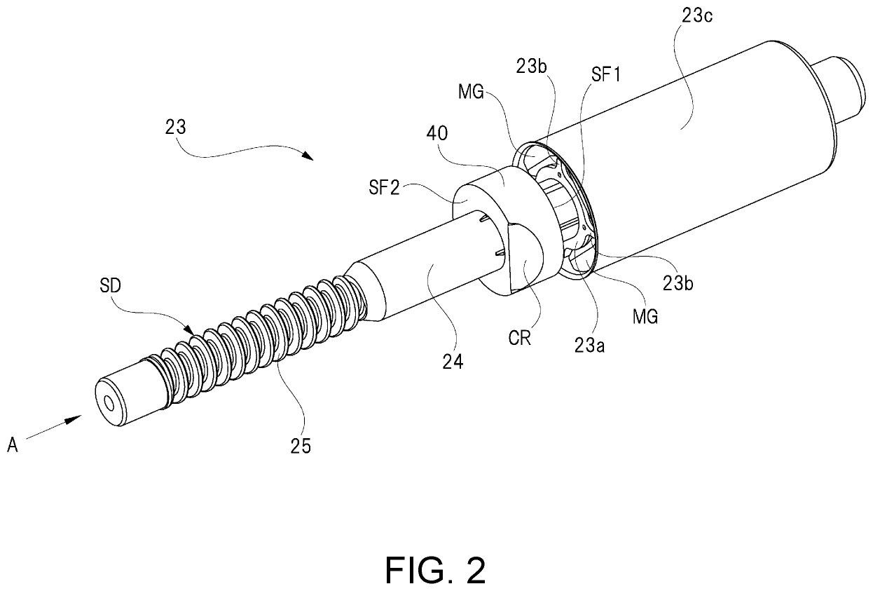

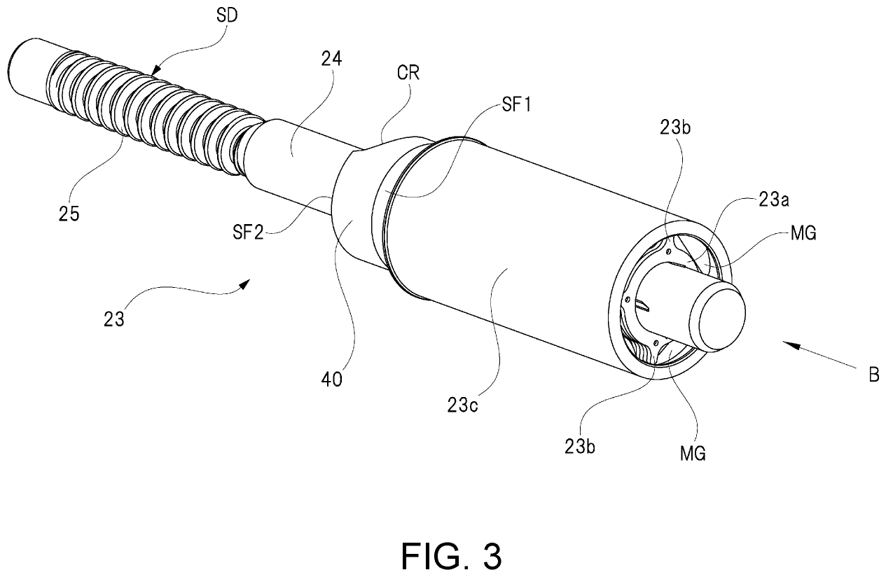

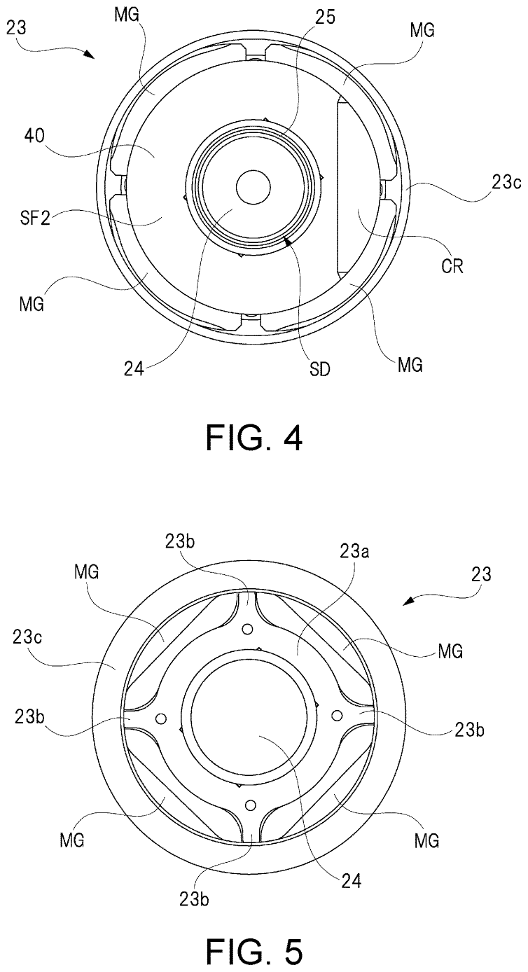

FIG. 1 is a cross-sectional view of a motor device along the axial direction of a rotor. FIG. 2 is a perspective view of the rotor as seen from the worm side. FIG. 3 is a perspective view of the rotor as seen from the rotor core side. FIG. 4 is a view taken in the direction of arrow A in FIG. 2. FIG. 5 is a view taken in the direction of arrow B in FIG. 3.

### <Overview of Motor Device>

The motor device 10 shown in FIG. 1 is used as the drive source of a sunroof device mounted on a roof of a vehicle such as an automobile. The motor device 10 is a motor device with a speed reduction mechanism, and has a flat shape because the motor device 10 is installed in a narrow space inside the roof. Thus, a worm speed reducer having a flat worm wheel 33 is adopted in a speed reduction mechanism SD while the diameter of a rotor 23 of an electric motor unit 20 is reduced. Specifically, in the motor device 10, the thickness dimension along the axial direction of an output shaft 34 is smaller than the length dimension along the axial direction of a shaft 24. The motor device 10 is operated by operating an operation switch inside a vehicle cabin, thereby opening and closing a roof panel that opens and closes an opening of the roof.

### <Structure of Motor Device>

As shown in FIG. 1, the motor device 10 includes an electric motor unit 20 and a speed reduction mechanism unit 30. The electric motor unit 20 and the speed reduction mechanism unit 30 are fixed to each other by multiple fixing screws SC (only one is shown in the drawing).

### <Electric Motor Unit>

The electric motor unit 20 uses a brushless motor. The electric motor unit 20 has a motor case 21, and the motor case 21 is formed into a cylindrical shape by deep drawing a steel plate or the like that is made of a magnetic body. The motor case 21 includes a side wall portion 21a, and the side wall portion 21a has a substantially regular hexagonal cross-sectional shape along a direction orthogonal to the axial direction of the motor case 21. Further, a stepped bottom wall portion 21b is provided on one axial side (right side in FIG. 1) of the side wall portion 21a.

### <Stator>

As shown in FIG. 1, a stator 22 is accommodated inside the motor case 21. The stator 22 has a stator core 22a formed by laminating multiple thin steel plates made of a magnetic body. The stator core 22a is fixed to the inner side of the motor case 21 and includes a total of six teeth 22b (not shown in detail). Three-phase coils CL composed of U phase, V phase, and W phase are wound around the teeth 22b via insulators 22c, respectively.

### <Rotor>

As shown in FIG. 1 to FIG. 5, a rotor 23 is rotatably provided on the radially inner side of the stator 22 via a predetermined air gap AG. The rotor 23 includes a rotor core 23a formed into a substantially cylindrical shape, and the rotor core 23a is formed by laminating multiple thin steel plates made of a magnetic body. Further, a total of four salient poles 23b are integrally provided on the radially outer side of the rotor core 23a, and the salient poles 23b protrude toward the radially outer side of the rotor core 23a and are arranged at equal intervals (90-degree intervals) in the circumferential direction, as shown in FIG. 5.

Magnets MG are respectively arranged between adjacent salient poles 23b in the circumferential direction of the rotor core 23a, and the magnets MG are fixed to the rotor core 23a by an adhesive or the like. That is, the rotor 23 is provided with a total of four magnets MG, and the magnets MG are also arranged at equal intervals (90-degree intervals) in the circumferential direction of the rotor core 23a.

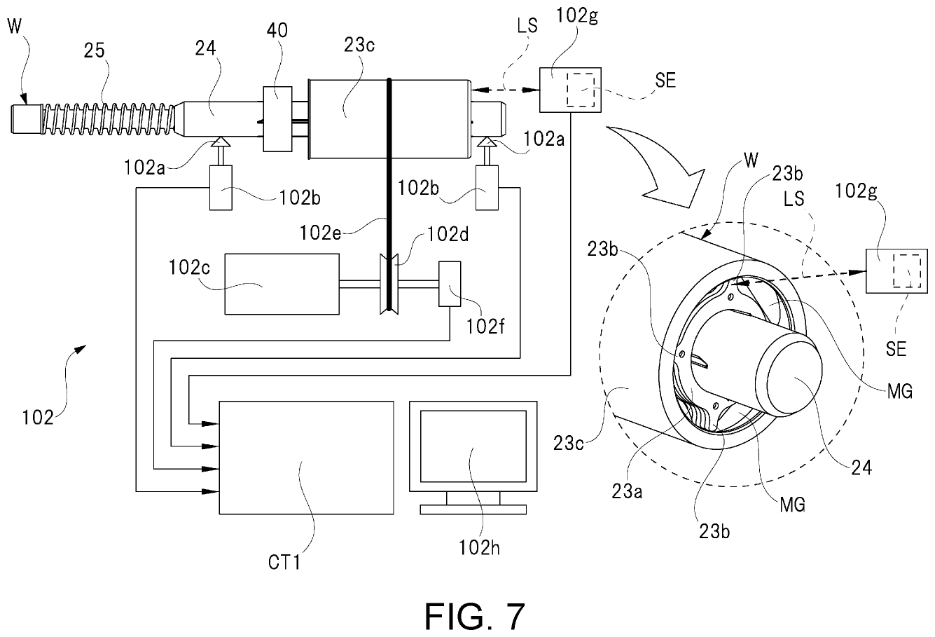

Here, as shown in the dashed circle in FIG. 1, on the bottom wall portion 21b side (right side in the drawing) along the axial direction of the rotor 23, an axial end portion T1 of the rotor core 23a is arranged closer to the bottom wall portion 21b than an axial end portion T2 of the magnet MG. In other words, in the axial direction of the rotor 23, a total of four salient poles 23b protrude beyond a total of four magnets MG. Accordingly, a step portion ST including the axial end portion T1 of the rotor core 23a and the axial end portion T2 of the magnet MG is formed on the bottom wall portion 21b side along the axial direction of the rotor 23. The step portion ST is utilized for detecting the rotation angle of the rotor 23 with respect to a bearing 102a (see FIG. 7) of a first balance measuring device 102 at the time of measuring the rotational balance of the rotor 23.

In addition, as shown in FIG. 2 and FIG. 3, a magnet holder 23c is mounted on the outer peripheral portion of a total of four magnets MG fixed to the rotor core 23a. The magnet holder 23c is formed into a substantially cylindrical shape with a thin stainless steel plate or the like, and supports the outer peripheral portion of each magnet MG. Accordingly, even if the rotor 23 rotates at a high speed, the magnets MG do not disengage from the rotor core 23a due to centrifugal force.

### <Shaft>

A shaft 24 is fixed to the rotation center of the rotor core 23a by press-fitting. In other words, the rotor 23 is provided on the shaft 24. One axial side of the shaft 24 (right side in FIG. 1) is accommodated inside the motor case 21, and is rotatably supported by a first bearing BR1 mounted on the bottom wall portion 21b of the motor case 21.

Furthermore, the other axial side of the shaft 24 (left side in FIG. 1) is accommodated inside a housing 31 forming the speed reduction mechanism unit 30, and is rotatably supported by a second bearing BR2 mounted on a worm accommodating portion 35 of the housing 31. Further, a worm 25 forming a speed reduction mechanism SD is integrally provided on the other axial side of the shaft 24.

### <Ball Bearing>

As shown in FIG. 1, a ball bearing 26 is provided at the axial center portion of the shaft 24. Here, the ball bearing 26 and the rotor core 23a holding the magnets MG are aligned with each other in the axial direction of the shaft 24, and the rotor core 23a holding the magnets MG is arranged between the ball bearing 26 and the first bearing BR1.

The ball bearing 26 also rotatably supports the shaft 24 in the same manner as the first bearing BR1 and the second bearing BR2. The ball bearing 26 has an inner ring 26a, an outer ring 26b, and multiple steel balls 26c. Further, cylindrical bearings, also referred to as so-called metal bearings, are used as the first bearing BR1 and the second bearing BR2.

### <Sensor Magnet Unit>

Furthermore, in the axial direction of the shaft 24, a sensor magnet unit 27 is provided between the worm 25 and the ball bearing 26. The sensor magnet unit 27 includes a bracket 27a fixed to the shaft 24 and a ring magnet 27b held by the bracket 27a. The sensor magnet unit 27 is used to detect the rotation direction, rotation speed, and the like (rotational state) of the rotor 23 including the shaft 24.

### <Weight>

Further, in the axial direction of the shaft 24, a weight 40 used to correct the rotational balance of the rotor 23 is fixed between the ball bearing 26 and the rotor core 23a including the magnets MG. In other words, the weight 40 is arranged coaxially with the rotor core 23a. The weight 40 is formed into a substantially cylindrical shape by laminating multiple thin steel plates made of a magnetic body in the same manner as the rotor core 23a, and is fixed to the shaft 24 by press-fitting.

The weight 40 is arranged closer to the ball bearing 26 than to the magnets MG in the axial direction of the shaft 24. Thus, a relatively large gap S is formed between the weight 40 and the magnets MG. Accordingly, the magnetic flux of the magnets MG is suppressed from being directed toward the weight 40, and thus the magnetic flux of the magnets MG can be directed toward the stator 22 efficiently. Therefore, the weight 40 made of a magnetic body does not adversely affect the output reduction of the electric motor unit 20.

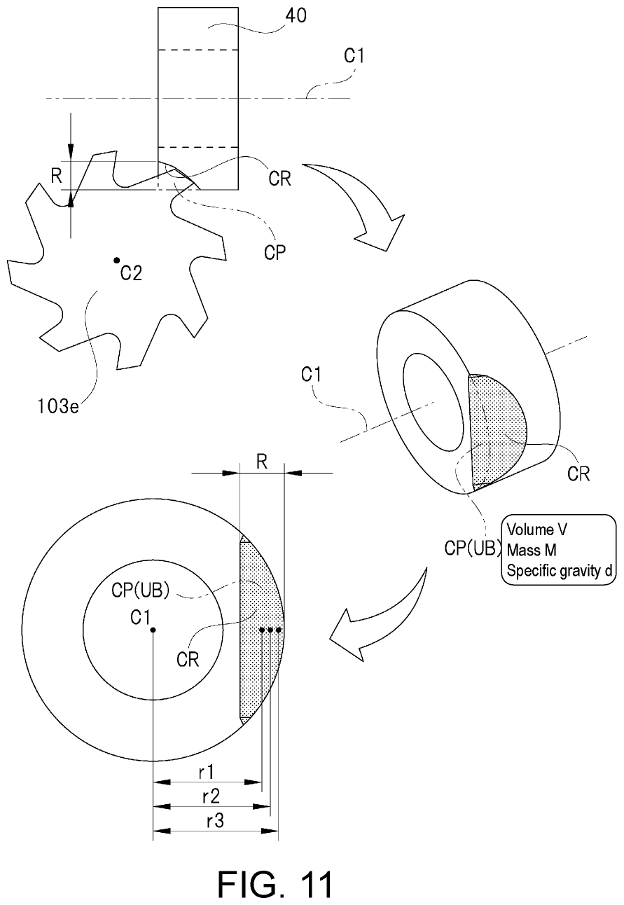

Here, the weight 40 is provided to eliminate rotational wobble caused by minute distortions and dimensional errors of components that differ in each product of the rotor 23. Specifically, at the time of assembling the rotor 23, the rotor 23 is rotated to measure the rotational balance, and in the case where the rotor 23 has poor rotational balance, a portion having a greater mass than other portions in the circumferential direction of the weight 40, that is, unbalanced portion UB (see FIG. 11), is cut and removed. This allows correction that improves the rotational balance of the rotor 23 as a whole (eliminates rotational wobble).

In the present embodiment, a portion of the rotor 23 where the weight is concentrated, that is, a portion of the rotor core 23a holding the magnets MG, cannot be cut. Therefore, the weight 40 is fixed coaxially with the rotor core 23a and the magnets MG, and a predetermined portion along the circumferential direction of the weight 40 is cut, thereby achieving the rotational balance of the rotor 23 as a whole. However, since the weight 40 is an inertial mass that is inherently unnecessary, it is desirable to make the weight 40 as small and lightweight as possible within a range in which the rotational balance of the rotor 23 as a whole is achievable.

By adjusting the rotational balance of the rotor 23 in this manner, rotational wobble of the rotor 23 is suppressed, and the operating noise of the electric motor unit 20 (motor device 10) is thus reduced (quietness is improved). In particular, since the motor device 10, which is the drive source of a sunroof device, is arranged above the heads of the driver and passengers, a loud operating noise may be unpleasant. Therefore, improving the quietness of the motor device 10 is an important issue. The method for achieving the rotational balance of the rotor 23 (rotational balance correction method) will be described in detail later.

### <Bearing Support Member>

Furthermore, the electric motor unit 20 includes a bearing support member 28. The bearing support member 28 is mounted to the housing 31, and supports the outer ring 26b of the ball bearing 26 from one axial side thereof. Accordingly, the ball bearing 26 is held between the housing 31 and the bearing support member 28 in the axial direction of the shaft 24. The bearing support member 28 is held between the motor case 21 and the housing 31 in the axial direction of the shaft 24.

### <Speed Reduction Mechanism Unit>

As shown in FIG. 1, the speed reduction mechanism unit 30 includes the housing 31 that accommodates the speed reduction mechanism SD. The housing 31 is made of a resin material such as plastic and formed into a flat and substantially rectangular parallelepiped shape. A worm wheel accommodating portion 32 is provided on the inner side of the housing 31, and a worm wheel 33 forming the speed reduction mechanism SD is rotatably accommodated inside the worm wheel accommodating portion 32. The worm wheel 33 is provided with a tooth portion 33a, and the tooth portion 33a meshes with a worm 25 inside the housing 31.

In this way, the speed reduction mechanism SD employs a worm speed reducer that provides a relatively large speed reduction ratio. Further, an output shaft 34 is fixed to the rotation center of the worm wheel 33, and the high-speed rotation of the shaft 24 is decelerated by the speed reduction mechanism SD, and a rotational force that has been decelerated and converted to high torque is output from the output shaft 34. The speed reduction mechanism SD is formed by the worm 25 and the worm wheel 33.

The worm accommodating portion 35 is provided on the inner side of the housing 31. The worm accommodating portion 35 is arranged in the vicinity of the worm wheel accommodating portion 32, and the interiors of the worm accommodating portion 35 and the worm wheel accommodating portion 32 are in communication with each other. This allows the worm 25 and the tooth portion 33a to mesh with each other. The housing 31 also supports the second bearing BR2 and the ball bearing 26. This prevents the worm 25 and the tooth portion 33a of the worm wheel 33 from disengaging from each other during operation of the motor device 10.

The inner ring 26a is fixed to the shaft 24, and the outer ring 26b is held between the housing 31 and the bearing support member 28. Accordingly, the shaft 24 does not move in the axial direction relative to the housing 31 and the motor case 21. Therefore, there is no need to provide thrust bearings on both axial sides of the shaft 24, which reduces the number of components.

### <Rotational Balance Correction Method for Rotor>

Next, the rotational balance correction method for the rotor 23 formed as described above will be described in detail with reference to the drawings. In the case of adjusting the rotational balance of the rotor 23, the work is performed in a state as shown in FIG. 2 and FIG. 3. That is, the rotational balance correction work for the rotor 23 is performed before the ball bearing 26 and the sensor magnet unit 27 are mounted to the shaft 24.

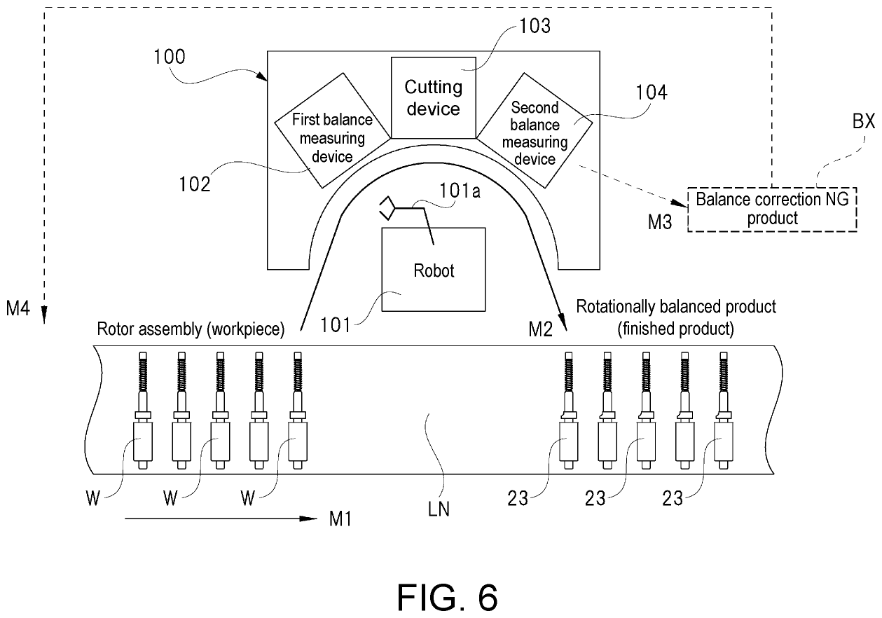

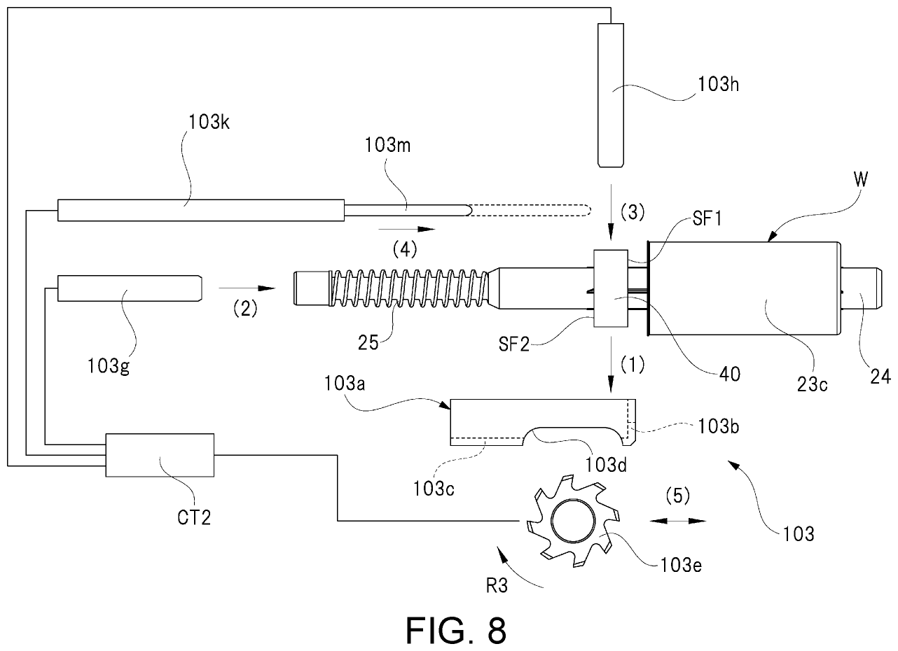

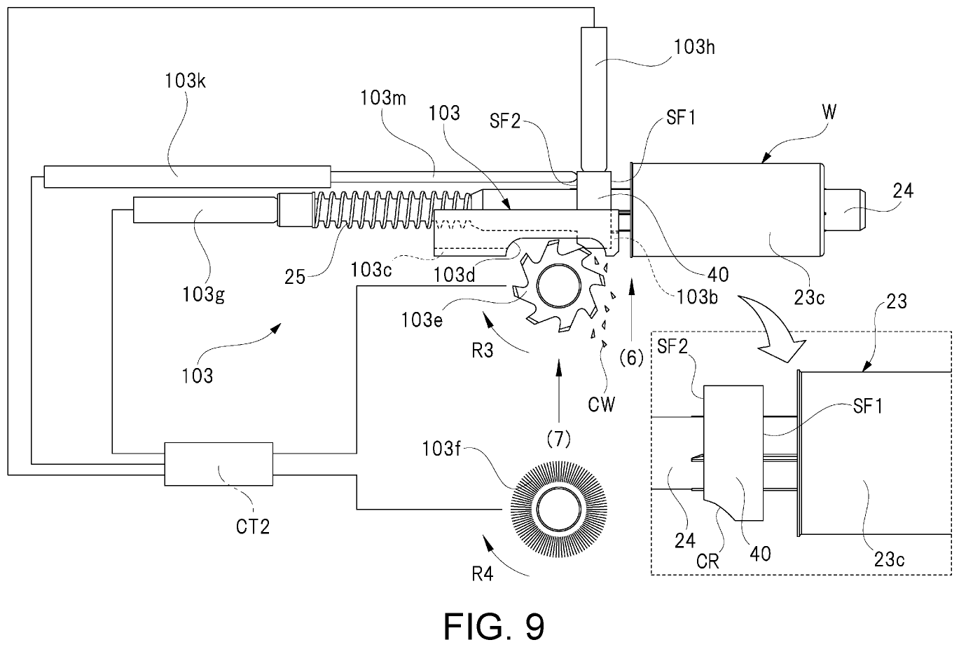

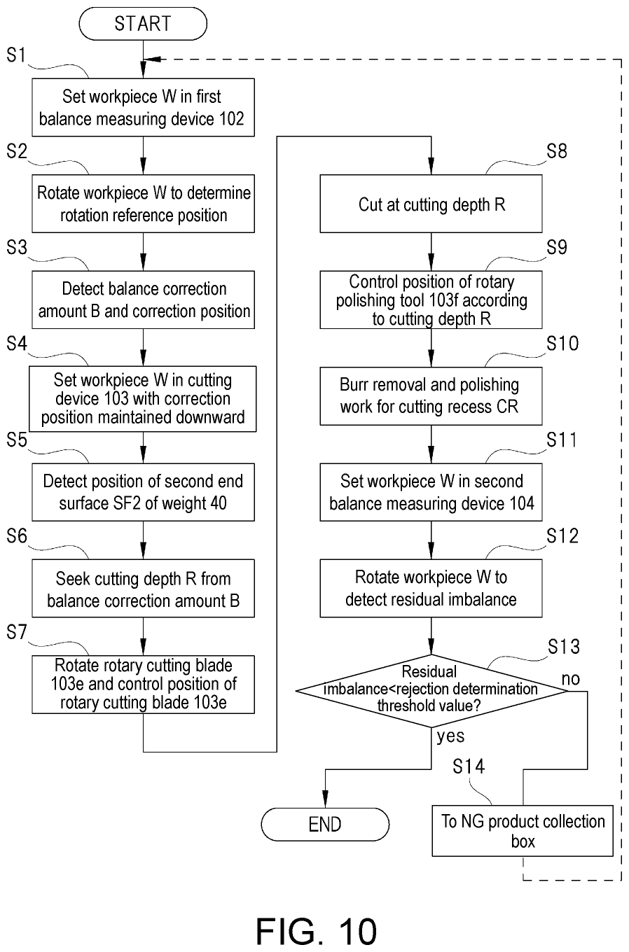

FIG. 6 is a schematic diagram showing a part of an assembly line LN of the rotor. FIG. 7 is a perspective view showing a first balance measuring device. FIG. 8 is a view for illustrating the operation of a preceding stage of a cutting device. FIG. 9 is a view for illustrating the operation of a subsequent stage of the cutting device. FIG. 10 is a flowchart showing the flow of the rotational balance correction work. FIG. 11 is a diagram showing a 3D model of a weight and a rotary cutting blade.

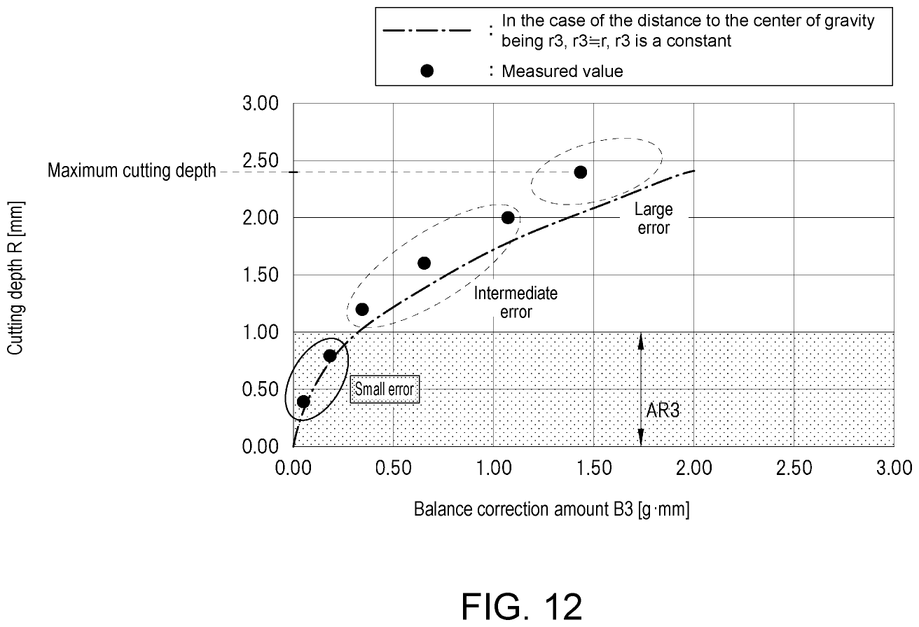

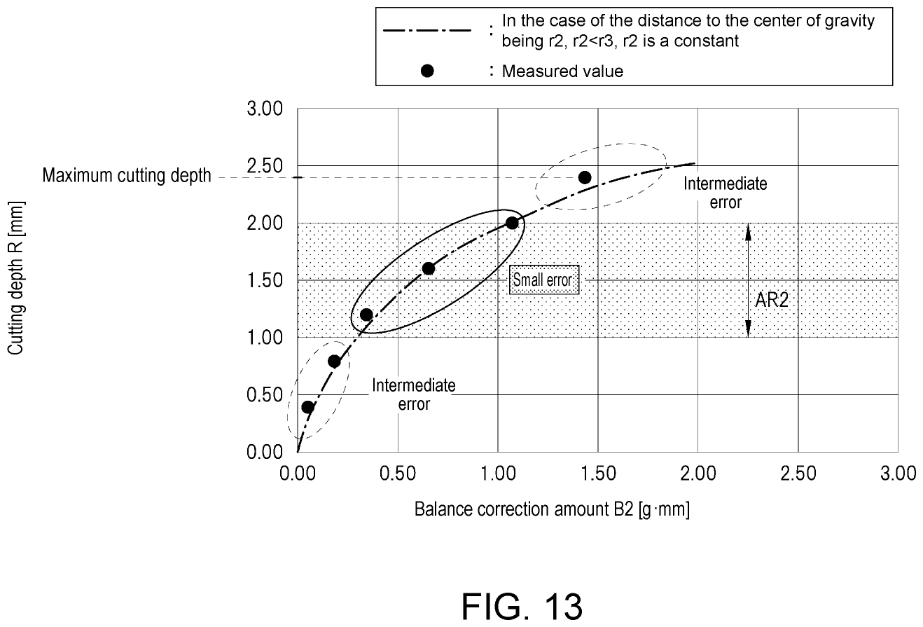

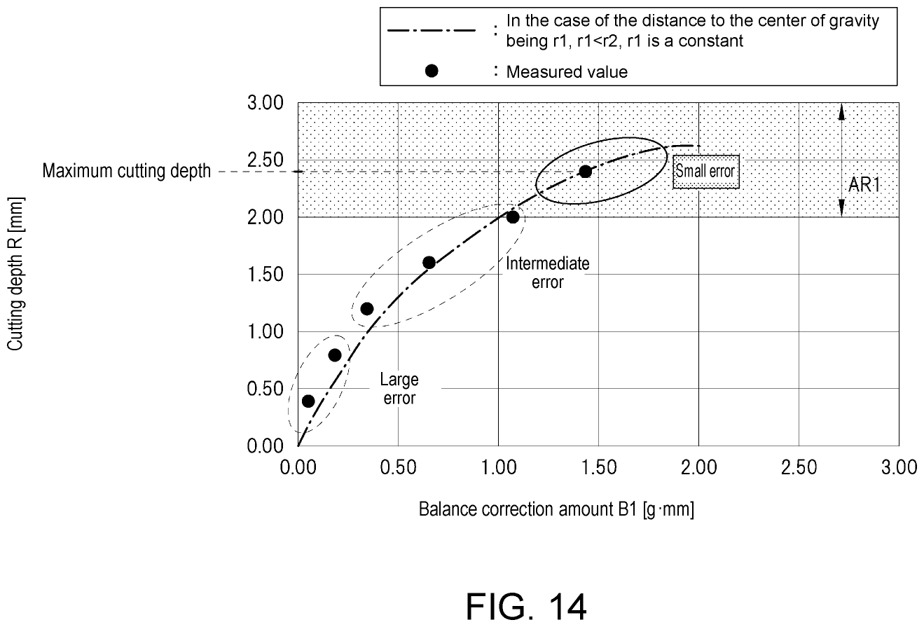

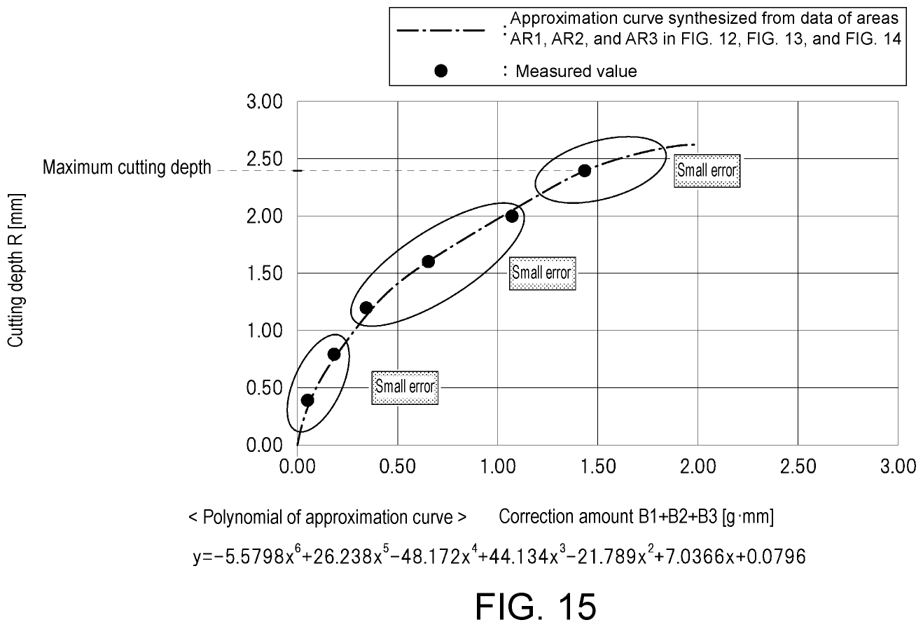

FIG. 12 is a graph showing plot data in the case where the distance from the rotation center of the weight to the center of gravity of a cut portion is r3. FIG. 13 is a graph showing plot data in the case where the distance from the rotation center of the weight to the center of gravity of the cut portion is r2 (r2<r3). FIG. 14 is a graph showing plot data in the case where the distance from the rotation center of the weight to the center of gravity of the cut portion is r1 (r1<r2). FIG. 15 is a graph showing an approximation curve synthesized from areas with small errors relative to measured values of the plot data in FIG. 12, FIG. 13, and FIG. 14.

Here, a rotor assembly before rotational balance is corrected is taken as a workpiece W. The workpiece W becomes the rotor 23 (finished product) shown in FIG. 2 and FIG. 3 through the rotational balance correction work shown in FIG. 6 and FIG. 10. Hereinafter, the procedure for measuring and correcting the rotational balance of the workpiece W will be described in detail with reference to the drawings. The workpiece W corresponds to the rotor in the disclosure.

### <Balancing Device>

First, a balancing device 100 for measuring and correcting the rotational balance of the workpiece W will be described based on FIG. 6 to FIG. 9. The balancing device 100 is provided in the middle of the assembly line LN of the rotor 23, and measures the rotational balance of the workpiece W and corrects the rotational balance of the workpiece W. Specifically, the balancing device 100 includes a robot 101, a first balance measuring device 102, a cutting device 103, and a second balance measuring device 104. The first balance measuring device 102 corresponds to the measuring device in the disclosure, and the cutting device 103 corresponds to the correction device in the disclosure.

### <Robot>

As shown in FIG. 6, the robot 101 includes an arm 101a capable of gripping the workpiece W. The robot 101 grips the workpiece W flowing along the assembly line LN as indicated by arrow M1 in the drawing, and moves the gripped workpiece W to the balancing device 100. Specifically, the robot 101 moves the workpiece W from the assembly line LN to the first balance measuring device 102 as indicated by arrow M2 in the drawing. The robot 101 also moves the workpiece W from the first balance measuring device 102 to the cutting device 103. Furthermore, the robot 101 moves the workpiece W from the cutting device 103 to the second balance measuring device 104.

Further, the robot 101 moves a rotationally balanced product (rotor 23 as a finished product), which has completed the rotational balance correction and passes, from the second balance measuring device 104 to the downstream side of the assembly line LN. Furthermore, the robot 101 moves a balance correction NG product (rejected product), for which the rotational balance correction could not be performed properly for some reason, from the second balance measuring device 104 to an NG product collection box BX, as indicated by dashed arrow M3 in the drawing.

Here, in the case where a balance correction NG product collected in the NG product collection box BX is determined by an operator or the like through visual inspection to have a high possibility of becoming a rotationally balanced product through a second balance correction, the balance correction NG product may be returned to the upstream side of the assembly line LN manually by the operator, as indicated by dashed arrow M4 in the drawing.

### <First Balance Measuring Device>

As shown in FIG. 7, the first balance measuring device 102 is provided with a pair of bearings 102a capable of rotatably supporting the workpiece W. Specifically, the pair of bearings 102a rotatably support the shaft 24 of the workpiece W. The pair of bearings 102a are each provided with a vibration sensor 102b that detects rotational runout of the workpiece W. The detection signals of the pair of vibration sensors 102b are input to a first controller CT1 that controls the first balance measuring device 102.

The first balance measuring device 102 is also provided with a drive motor 102c that is controllable by the first controller CT1. Further, a rubber belt 102e is engaged with a pulley 102d of the drive motor 102c. The rubber belt 102e crosses between the pair of bearings 102a and is engaged with the outer peripheral surface of the magnet holder 23c of the workpiece W set in the pair of bearings 102a. Accordingly, as the drive motor 102c rotates, the workpiece W is rotated via the rubber belt 102e.

Further, the drive motor 102c is provided with a rotary encoder 102f that detects the rotational state of the pulley 102d. Specifically, the rotary encoder 102f outputs a pulse signal to the first controller CT1 as the pulley 102d rotates. Here, the first controller CT1 uses the total pulse number from the rotary encoder 102f for one rotation of the workpiece W as a reference pulse number, and divides 360 degrees by the reference pulse number to obtain a rotation angle of the workpiece W per pulse. Here, the reference pulse number is stored in advance in a RAM or the like provided in the first controller CT1.

Furthermore, the first balance measuring device 102 is provided with a laser displacement meter 102g including a CMOS (Complementary Metal Oxide Semiconductor) image sensor SE. The laser displacement meter 102g irradiates laser light LS toward one axial side of the workpiece W (right side in the drawing) and receives reflected light from the workpiece W. Thereby, the first controller CT1 determines a rotation reference position (0-degree position) of the workpiece W. Specifically, the first controller CT1 detects the positions of four salient poles 23b protruding toward one axial side of the workpiece W on the one axial side of the workpiece W, and sets one of the positions as the rotation reference position. The laser displacement meter 102g corresponds to the rotation detection sensor in the disclosure.

Accordingly, while rotating the workpiece W set on the pair of bearings 102a, the first controller CT1 grasps the detection signals from the pair of vibration sensors 102b and grasps the rotation angle of the workpiece W, thereby calculating where and how much mass the unbalanced portion UB is located in the circumferential direction of the weight 40 of the workpiece W. After calculating the position and mass of the unbalanced portion UB, the first controller CT1 displays the results on a display 102h. In this way, the first balance measuring device 102 has a function of measuring the rotational balance of the workpiece W.

Here, the second balance measuring device 104 (see FIG. 6) at a subsequent stage of the balancing device 100 has a similar configuration to the first balance measuring device 102 described above, and therefore, detailed description thereof is omitted. The second balance measuring device 104 has a function of rotating the workpiece W that has been processed in the cutting device 103, that is, workpiece W after rotational balance correction, and finally checking the rotational balance of the workpiece W. In other words, the second balance measuring device 104 has a function of determining whether the workpiece W that has completed the rotational balance correction passes or not.

### <Cutting Device>

As shown in FIG. 8 and FIG. 9, the cutting device 103 includes a workpiece setting portion 103a formed into a substantially dish shape. The weight 40 before cutting is accommodated on the inner side of the workpiece setting portion 103a. Specifically, the workpiece setting portion 103a has a side wall 103b and a bottom wall 103c, and a first end surface SF1 on one axial side (right side in the drawing) of the weight 40 is abutted against the side wall 103b.

Further, the bottom wall 103c has a through hole 103d penetrating in a direction orthogonal to the axial direction of the workpiece W. A rotary cutting blade 103e and a rotary polishing tool 103f forming the cutting device 103 are configured to freely enter and exit the through hole 103d from a direction orthogonal to the axial direction of the workpiece W. This makes it possible to cut and polish a second end surface SF2 on the other axial side (left side in the drawing) of the weight 40 arranged in the vicinity of the through hole 103d. The rotary cutting blade 103e corresponds to the cutting tool in the disclosure.

Furthermore, the cutting device 103 includes a shaft support 103g capable of supporting the workpiece W from the other axial side thereof. The shaft support 103g is movable in the axial direction of the workpiece W under control of a second controller CT2. In addition, the shaft support 103g fixes the shaft 24 set in the workpiece setting portion 103a without rattling in the axial direction thereof.

Further, the cutting device 103 includes a weight support 103h capable of moving up and down in a direction orthogonal to the axial direction of the workpiece W. The weight support 103h is driven to move up and down under control of the second controller CT2, and presses the weight 40 set in the workpiece setting portion 103a toward the bottom wall 103c from the radially outer side thereof. Accordingly, the weight 40 set in the workpiece setting portion 103a is fixed without rattling in the radial direction thereof.

In this way, the workpiece W set in the workpiece setting portion 103a is fixed without rattling in the axial direction and radial direction thereof by the shaft support 103g and the weight support 103h. This makes it possible to accurately perform cutting work of the weight 40 with the rotary cutting blade 103e.

Furthermore, the cutting device 103 is provided with a contact type displacement sensor 103k. The displacement sensor 103k is connected to the second controller CT2, and has a function of detecting the axial position of the weight 40 set in the workpiece setting portion 103a. Specifically, by abutting a contact 103m of the displacement sensor 103k against the second end surface SF2 on the other axial side of the weight 40, the second controller CT2 can accurately grasp the axial position of the weight 40 relative to the workpiece setting portion 103a. Thus, the displacement sensor 103k detects the position of one end surface (second end surface SF2) along the axial direction of the weight 40, and corresponds to the end surface detection sensor in the disclosure.

Here, an optical type displacement sensor without a contact may also be used, but in this case, there is a risk that the detection accuracy may become unstable due to variations in surface roughness of the second end surface SF2 for each product, contamination of the surroundings of the cutting device 103, and the like. Thus, in the present embodiment, a contact type displacement sensor is used. This enables the second controller CT2 to accurately position the rotary cutting blade 103e and the rotary polishing tool 103f in the axial direction thereof relative to the weight 40 set in the workpiece setting portion 103a. Accordingly, the rotational balance correction work (cutting and polishing work) for the workpiece W can be performed with high accuracy. In this way, the cutting device 103 has a function of cutting the weight 40 to correct the rotational balance of the workpiece W.

### <Flow of Rotational Balance Correction Work>

The rotational balance correction work for the workpiece W is performed in accordance with the flowchart shown in FIG. 10. Specifically, in response to the balancing device 100 being started (START), the robot 101 is activated. Then, in step S1, the arm 101a grips the workpiece W flowing on the assembly line LN and sets the gripped workpiece W on the bearings 102a of the first balance measuring device 102.

In step S2, the drive motor 102c is driven by the first controller CT1 (see FIG. 7), and in response thereto, the workpiece W is rotated at a predetermined rotation speed via the rubber belt 102e. Further, in step S2, the first controller CT1 determines the rotation reference position (0-degree position) of the workpiece W relative to the bearings 102a based on information from the laser displacement meter 102g. Specifically, the first controller CT1 determines any one of a total of four salient poles 23b as the 0-degree position.

In step S3, the first controller CT1 of the first balance measuring device 102 executes a process of rotating the workpiece W with the 0-degree position as a reference and specifying where and how much mass the unbalanced portion UB (portion having a large mass in the circumferential direction of the weight 40) is located in the circumferential direction of the weight 40. Specifically, in step S3, the first controller CT1 seeks a balance correction amount B [g·mm] to be removed from the weight 40 based on the detection signals from the vibration sensor 102b, the rotary encoder 102f, and the laser displacement meter 102g, and specifies the angular position (position) of the unbalanced portion UB along the circumferential direction of the weight 40.

Here, in the case where there is an unbalanced portion UB with a mass M [g] having a center of gravity at a position at a distance r [mm] from the rotation center of the weight 40 in the radial direction of the weight 40, the balance correction amount B [g·mm] is indicated by a product of distance r [mm] and mass M [g]. Then, the first controller CT1 compares the detection signals from the vibration sensor 102b, the rotary encoder 102f, and the laser displacement meter 102g with data stored in advance in a RAM or the like of the first controller CT1, and seeks the balance correction amount B [g·mm] based on the data.

The angular position at which the unbalanced portion UB is arranged in the circumferential direction of the weight 40 serves as a correction position at which the cutting work is performed later. That is, the correction position serves as a portion against which the rotary cutting blade 103e and the rotary polishing tool 103f of the cutting device 103 are abutted. Further, the balance correction amount B [g·mm] sought in step S3 is used as a factor for determining a cutting depth R [mm] of the rotary cutting blade 103e of the cutting device 103 relative to the weight 40.

Then, after seeking the balance correction amount B [g·mm] and the angular position (correction position) of the unbalanced portion UB in step S3, the first controller CT1 stops the drive motor 102c so that the correction position is arranged downward (directly below in the vertical direction). This completes the rotational balance measurement work for the workpiece W performed by the first balance measuring device 102. The process in step S3 performed by the first balance measuring device 102 corresponds to the rotational balance measurement step in the disclosure.

In step S4, the arm 101a of the robot 101 moves the workpiece W from the first balance measuring device 102 to the cutting device 103. At this time, the arm 101a sets the workpiece W in the workpiece setting portion 103a of the cutting device 103 as indicated by arrow (1) in FIG. 8, with the workpiece W maintained in a posture in which the correction position is arranged downward.

In step S4, the second controller CT2 further drives the shaft support 103g and the weight support 103h to fix the workpiece W so as not to rattle relative to the workpiece setting portion 103a. Specifically, as indicated by arrow (2) in FIG. 8, the shaft support 103g first supports the workpiece W in the axial direction. Thereafter, as indicated by arrow (3) in FIG. 8, the weight support 103h supports the weight 40 in the radial direction.

In step S5, the second controller CT2 moves the contact 103m of the displacement sensor 103k as indicated by arrow (4) in FIG. 8, and abuts the tip (right end in the drawing) of the contact 103m against the second end surface SF2 of the weight 40. Thereby, the second controller CT2 grasps the position of the second end surface SF2 of the weight 40 based on the detection signal from the displacement sensor 103k.

In step S6, the second controller CT2 of the cutting device 103 seeks the cutting dep R [mm] from the balance correction amount B [g·mm] calculated in step S3, using a polynomial y=−5.5798x⁶+26.238x⁵−48.172x⁴+44.134x³−21.789x²+7.0366x+0.0796 stored in advance in a RAM or the like. Here, by substituting the balance correction amount B [g·mm] into “x” of the polynomial, “y” as the cutting depth R [mm] can be sought. Details of the above polynomial used in step S6 (determination method, etc.) will be described later.

In step S7, the second controller CT2 rotates the rotary cutting blade 103e at predetermined rotation speed and rotation direction as indicated by arrow R3 in FIG. 8. In addition, the second controller CT2 controls the position of the rotary cutting blade 103e relative to the axial direction of the weight 40 as indicated by arrow (5) in FIG. 8, based on the position information of the second end surface SF2 detected in step S5, that is, the detection signal from the displacement sensor 103k.

In step S8, the second controller CT2 raises the rotary cutting blade 103e while rotating the rotary cutting blade 103e as indicated by arrow (6) in FIG. 9, and abuts the rotary cutting blade 103e against the weight 40 via the through hole 103d. The raising control for the rotary cutting blade 103e performed by the second controller CT2 follows the cutting depth R [mm] sought in step S6. This causes the second end surface SF2 side along the axial direction of the weight 40 to be cut at the cutting depth R [mm], and consequently, a cutting recess CR is formed on the second end surface SF2 side along the axial direction of the weight 40. The processing from step S6 to step S8 performed by the cutting device 103 corresponds to the rotational balance correction step in the disclosure.

The cutting depth R [mm] in the present embodiment is a dimension from the radially outer side of the weight 40 to the deepest portion of the cutting recess CR (see FIG. 11). In addition, during the cutting process of the weight 40 performed by the rotary cutting blade 103e, cutting chips CW of the weight 40 fall down from the through hole 103d as illustrated in FIG. 9. Thus, the inner side of the workpiece setting portion 103a is suppressed from contamination caused by the cutting chips CW of the weight 40, and thus the effort of cleaning the workpiece W after cutting can be saved.

In step S9, the second controller CT2 first stops the rotary cutting blade 103e that has completed the cutting work and returns the rotary cutting blade 103e to a storage position. Next, the second controller CT2 rotates the rotary polishing tool 103f as indicated by arrow R4, and raises the rotary polishing tool 103f by the cutting depth R [mm] as indicated by arrow (7) in FIG. 9. Here, since the outer diameter of the rotary polishing tool 103f is substantially the same as the outer diameter of the rotary cutting blade 103e, the rotary polishing tool 103f can be controlled in the same manner as the position control of the rotary cutting blade 103e for the weight 40. Therefore, the second controller CT2 does not need to individually control the position of the rotary polishing tool 103f, which can reduce the control load on the second controller CT2.

In step S10, the second controller CT2 abuts the rotating rotary polishing tool 103f against the cutting recess CR for a predetermined time. This removes unnecessary matter such as burrs remaining on the surface of the cutting recess CR, and the surface of the cutting recess CR is polished cleanly. The rotation direction R4 of the rotary polishing tool 103f is the same as the rotation direction R3 of the rotary cutting blade 103e. Therefore, polishing chips (not shown) from the rotary polishing tool 103f also fall down from the through hole 103d.

In step S11, the workpiece W in the cutting device 103 is moved to the second balance measuring device 104 by the arm 101a of the robot 101. Specifically, the arm 101a sets the workpiece W on a pair of bearings (not shown) of the second balance measuring device 104.

In step S12, the workpiece W is rotated by a controller (not shown) of the second balance measuring device 104, and the rotational balance of the workpiece W that has completed the cutting work is measured. Specifically, the controller of the second balance measuring device 104 seeks the residual imbalance [g·mm] of the workpiece W that has completed the cutting work.

In step S13, a process of comparing the residual imbalance [g·mm] after cutting work sought in step S12 with a predetermined rejection determination threshold value is performed by the controller of the second balance measuring device 104. In other words, in step S13, whether the workpiece W passes or not (OK or NG) after the cutting work, that is, after rotational balance is achieved, is determined.

In the case where the controller of the second balance measuring device 104 determines that the residual imbalance [g·mm] after cutting work is a value close to “0” and smaller than the rejection determination threshold value (determination as yes), the workpiece W becomes a rotationally balanced product (finished product), and the rotational balance correction work is completed (END). Thereafter, the arm 101a of the robot 101 moves the rotationally balanced product, that is, the rotor 23 that has become a finished product, to the downstream side of the assembly line LN.

On the other hand, in the case where the controller of the second balance measuring device 104 determines that the residual imbalance [g·mm] after cutting work is a relatively large value and is equal to or greater than the rejection determination threshold value (determination as no), the workpiece W becomes a balance correction NG product (rejected product). Thereafter, in step S14, the arm 101a of the robot 101 moves the balance correction NG product to the NG product collection box BX. Here, the balance correction NG product collected in the NG product collection box BX may be returned to step S1 as indicated by the dashed arrow in FIG. 10 according to the judgment and manual work of the operator.

Here, as a result of prototyping multiple rotors 23 and investigating the finish, it was found that most of the rotors 23 became rotationally balanced products (finished products) through a single rotational balance correction work. It was also found that even when a balance correction NG product (rejected product) was produced, the product became an acceptable product through a second rotational balance correction work. In other words, no rotor 23 requiring a third rotational balance correction work was produced.

### <Regarding Polynomial>

Next, the method for seeking the polynomial y=−5.5798x⁶+26.238x⁵−48.172x⁴+44.134x³−21.789x²+7.0366x+0.0796 stored in advance in a RAM or the like of the second controller CT2 forming the cutting device 103 will be described in detail. Specifically, the above polynomial is sought by a computer through the following procedures (1) to (9).
(1) For example, first, as shown in FIG. 11, a 3D (three-dimensional) model of a weight 40 to be rotated about a rotation center C1 and a rotary cutting blade 103e to be rotated about a rotation center C2 is created (prepared) using a function of CAD software installed in the computer.
(2) Next, on the 3D model prepared in (1), the rotary cutting blade 103e is arranged so as to achieve a cutting depth R [mm] (an arbitrary value) from the radially outer side of the weight 40.
(3) Then, a volume V [mm³] of a cut portion CP (see the hatched portion in FIG. 11) to be cut by the rotary cutting blade 103e is sought. Here, the cut portion CP corresponds to the unbalanced portion UB, and the volume V of the cut portion CP is also sought using a function of CAD software. Specifically, the volume V of the cut portion CP is the volume of a portion where the rotation trajectory of the rotary cutting blade 103e and the weight 40 overlap, and is sought with ease by a function of CAD software.
(4) Thereafter, the volume V sought in (3) is multiplied by a specific gravity d [g/mm³] of the weight 40 obtained from a material of the weight 40, to seek a mass M [g] of the cut portion CP (M=V×d).
(5) By multiplying the mass M sought in (4) by a distance r from the rotation center C1 of the weight 40 to the center of gravity of the cut portion CP, a balance correction amount B [g·mm] can be sought (B=M×r). Here, since the cut portion CP has a complex shape, it is difficult to seek the distance r precisely.

Therefore, in the present embodiment, three simplified distances r1, r2, and r3 are prepared. For example, the distances r1, r2, and r3 are obtained by dividing the cutting depth R into three arbitrary areas AR1 (an area from 2.00 mm to 3.00 mm in FIG. 14), AR2 (an area from 1.00 mm to 2.00 mm in FIG. 13), and AR3 (an area from 0.00 mm to 1.00 mm in FIG. 12), and calculating a theoretical distance r corresponding to the cutting depth R that is at a maximum in each area. The distances r1, r2, and r3 have a relationship of r1<r2<r3, and for the weight 40 of the present embodiment, r1=6.1 mm, r2=6.6 mm, and r3=7.1 mm.
(6) According to the distances r3, r2, and r1 prepared in (5), balance correction amounts B3=M×r3, B2=M×r2, and B1=M×r1 are sought, respectively. Then, as shown in FIG. 12, FIG. 13, and FIG. 14, three graphs are created with the balance correction amounts B3, B2, and B1 on the x-axis and the cutting depth R on the y-axis. Then, the balance correction amounts B3, B2, and B1 and the cutting depth R are plotted on the respective graphs.
(7) By changing the cutting depth R and repeating (3) to (6), the balance correction amounts B3, B2, and B1 and the cutting depth R are plotted on the respective graphs. Thereby, according to the distances r3, r2, and r1, graphs of curves as indicated by the dashed-dotted lines in FIG. 12, FIG. 13, and FIG. 14 are created. The plot data serving as the basis of these graphs is obtained, for example, by changing the cutting depth R in increments of 0.1 mm up to 2.4 mm for 24 times. Here, the maximum value of the cutting depth R (2.4 mm in the present embodiment) is determined in accordance with the size of the weight 40.
(8) Then, in the area AR3 where the cutting depth R is shallow (small), plot data of the balance correction amount B3 and the cutting depth R are used. Further, in the area AR2 where the cutting depth R is intermediate, plot data of the balance correction amount B2 and the cutting depth R are used. Further, in the area AR1 where the cutting depth R is deep (large), plot data of the balance correction amount B1 and the cutting depth R are used. Then, as shown in FIG. 15, the respective plot data in the shallow area AR3, the intermediate area AR2, and the deep area AR1 are consolidated onto one graph. Thereby, errors with respect to measured values are reduced over the entire range of the graph of the synthesized curve. Here, the errors determine the quality of rotational balance, and it can be said that the smaller the errors, the better the rotational balance (substantially no unbalanced portion UB).
In (8), the areas in which the plotted data is used may also be determined by comparing the three graphs (plot data) of curves shown in FIG. 12, FIG. 13, and FIG. 14 with the measured values. Specifically, the areas may be determined by the following method. As shown in FIG. 12, among the plot data of the balance correction amount B3 and the cutting depth R, an area where the error with respect to the measured values is smaller compared to other plot data is designated as area AR3′ (not shown). Further, as shown in FIG. 13, among the plot data of the balance correction amount B2 and the cutting depth R, an area where the error with respect to the measured values is smaller compared to other plot data is designated as area AR2′ (not shown). Further, as shown in FIG. 14, among the plot data of the balance correction amount B1 and the cutting depth R, an area where the error with respect to the measured values is smaller compared to other plot data is designated as area AR1′ (not shown).

In addition, area AR1 and area AR1′, area AR2 and area AR2′, and area AR3 and area AR3′ may be areas different from each other, respectively. Furthermore, although the areas in which the plotted data is used are determined according to the cutting depth R, the areas may also be determined according to the balance correction amount B.

Here, the measured values are obtained by preparing multiple rotors (workpieces) having an imbalance amount of substantially “0” and good rotational balance for measured value measurement, cutting the weights of these workpieces at an arbitrary cutting depth R to measure the imbalance amount (balance correction amount), and repeating this process. Therefore, obtaining multiple measured values requires manufacturing workpieces with high precision and preparing multiple such workpieces, which takes a considerable amount of time. Thus, in the present embodiment, a total of six measured values (minimum measured values required) are prepared to span from the shallow area AR3 to the deep area AR1 of the cutting depth R, and the reliability of the graph of the synthesized curve is confirmed.
(9) Then, an approximation curve (see the dashed-dotted line in FIG. 15) is created that passes near the plot data (plot data in the shallow area AR3, the intermediate area AR2, and the deep area AR1) consolidated into a single graph of a curve in (8), and a polynomial of the approximation curve is sought. That is, the graph (approximation curve) indicated by the dashed-dotted line in FIG. 15 is indicated by a polynomial y=−5.5798x⁶+26.238x⁵−48.172x⁴+44.134x³−21.789x²+7.0366x+0.0796.

As described in detail above, according to the present embodiment, the cutting depth R [mm] along the radial direction of the weight 40 can be readily obtained from the balance correction amount B [g·mm] obtained in the rotational balance measurement step, based on the calculation formula (polynomial y=−5.5798x⁶+26.238x⁵−48.172x⁴+44.134x³−21.789x²+7.0366x+0.0796) obtained by desk calculation (computer), and a transition to the rotational balance correction step can be made promptly.

Further, since the calculation formula (polynomial) stored in the second controller CT2 is a formula that takes into account changes in the cutting depth R of the cut portion CP, the rotational balance of the workpiece W can be corrected with high accuracy even for a deep cutting depth R of the cut portion CP. Thus, the occurrence of defective rotors 23 can be suppressed, which consequently makes it possible to reduce the manufacturing cost of the motor device 10.

Furthermore, according to the present embodiment, the rotor core 23a is provided with multiple salient poles 23b protruding radially outward, magnets MG are respectively arranged between adjacent salient poles 23b in the circumferential direction of the rotor core 23a, the multiple salient poles 23b protrude beyond the magnets MG in the axial direction of the rotor 23, the first balance measuring device 102 is provided with a laser displacement meter 102g that detects the positions of the salient poles 23b, and in the rotational balance measurement step, and the position of the unbalanced portion UB in the circumferential direction of the weight 40 is specified based on the detection signal from the laser displacement meter 102g.

Accordingly, the first controller CT1 can determine the rotation reference position (0-degree position) of the rotor 23 (workpiece W before rotational balance is corrected) without providing a marker or the like for position detection on the rotor 23. The first controller CT1 can then specify the position of the unbalanced portion UB along the circumferential direction of the weight 40 with reference to the rotation reference position.

Further, according to the present embodiment, the cutting device 103 is provided with a displacement sensor 103k that detects the position of a second end surface SF2 on one side along the axial direction of the weight 40, and in the rotational balance correction step, the position of a rotary cutting blade 103e with respect to the axial direction of the weight 40 is controlled based on the detection signal from the displacement sensor 103k.

Accordingly, it is possible to perform the cutting work (balancing work) of the weight 40 efficiently and accurately. This can also further suppress the occurrence of defective rotors 23, which consequently makes it possible to further reduce the manufacturing cost of the motor device 10.

Furthermore, according to the present embodiment, the occurrence of defective rotors 23 can be suppressed as described above, so it is possible to save manufacturing energy of the rotor 23. This can achieve, in particular, Goal 7 (ensure access to affordable, reliable, sustainable and modern energy for all) and Goal 13 (take urgent action to combat climate change and its impacts) of the Sustainable Development Goals (SDGs) established by the United Nations.

The disclosure is not limited to the above embodiment, and it goes without saying that various modifications may be made without departing from the spirit of the disclosure. The above embodiment illustrates a case in which three distances r1, r2, and r3 from the rotation center C1 of the weight 40 are prepared to seek the calculation formula (polynomial y=−5.5798x⁶+26.238x⁵−48.172x⁴+44.134x³−21.789x²+7.0366x+0.0796), but the disclosure is not limited thereto. For example, four or more distances from the rotation center C1 of the weight 40 may be prepared to seek the calculation formula (polynomial). In this case, a calculation formula (polynomial) with higher accuracy can be obtained to further improve the rotational balance of the rotor.

Further, the above embodiment illustrates a case in which the disclosure is applied to the rotor 23 of the motor device 10 used as the drive source of a sunroof device, but the disclosure is not limited thereto. The disclosure may also be applied to, for example, an in-vehicle compact motor (brushless motor) used in a slide door device, a power window device, a wiper device, or the like mounted on a vehicle.

In addition, the material, shape, dimensions, number, installation location, and the like of each component in the above embodiment are arbitrary as long as the disclosure can be achieved, and are not limited to the above embodiment.

What is claimed is:

1. A rotational balance correction method for correcting rotational balance of a rotor,
wherein the rotor comprises:
a shaft;
a rotor core provided on the shaft;
a magnet provided on the rotor core; and
a weight provided on the shaft and arranged coaxially with the rotor core,
wherein a measuring device measuring rotational balance of the rotor, and a correction device correcting rotational balance of the rotor by cutting the weight are used,
wherein the measuring device executes a rotational balance measurement step of rotating the rotor, and in the case where there is an unbalanced portion with a mass M having a center of gravity at a position at a distance r from a rotation center of the rotor in a radial direction of the weight, seeking a balance correction amount B indicated by a product of the distance r and the mass M, and specifying a position of the unbalanced portion in a circumferential direction of the weight,
wherein the correction device executes a rotational balance correction step of using a calculation formula for obtaining a cutting depth R along the radial direction of the weight from the balance correction amount B to control a cutting tool so as to achieve the cutting depth R obtained by substituting the balance correction amount B into the calculation formula, and cutting the unbalanced portion of the weight, and
wherein the calculation formula is a polynomial sought by a computer through the following procedures (1) to (9):
(1) prepare a 3D model of the weight and the cutting tool,
(2) arrange the cutting tool on the 3D model so as to achieve the cutting depth R from a radially outer side of the weight,
(3) seek a volume V of a cut portion to be cut by the cutting tool,
(4) seek a mass M of the cut portion by multiplying the volume V by a specific gravity d of the weight,
(5) prepare at least three different distances r1, r2, and r3 (r1<r2<r3) as a distance r from a rotation center of the weight to a center of gravity of the cut portion,
(6) seek balance correction amounts B1=M×r1, B2=M×r2, and B3=M×r3 respectively according to the distances r1, r2, and r3, create at least three graphs with the balance correction amounts B1, B2, and B3 on an x-axis and the cutting depth R on a y-axis, and plot the balance correction amounts B1, B2, and B3 and the cutting depth R respectively on the graphs,
(7) repeat (3) to (6) by changing the cutting depth R, and plot the balance correction amounts B1, B2, and B3 and the cutting depth R respectively on the graphs,
(8) determine areas in which plotted data is used according to the cutting depth R or the balance correction amount B, use plot data of the balance correction amount B3 and the cutting depth R in an area where the cutting depth R or the balance correction amount B is small, use plot data of the balance correction amount B2 and the cutting depth R in an area where the cutting depth R or the balance correction amount B is intermediate, use plot data of the balance correction amount B1 and the cutting depth R in an area where the cutting depth R or the balance correction amount B is large, and consolidate the plot data on one graph, and
(9) seek a polynomial indicating an approximation curve passing near the plot data consolidated on one graph.

2. The rotational balance correction method according to claim 1, wherein the rotor core comprises a plurality of salient poles protruding radially outward,
the magnet is arranged between the salient poles adjacent to each other in a circumferential direction of the rotor core,
in an axial direction of the rotor, the plurality of salient poles protrude beyond the magnet,
the measuring device comprises a rotation detection sensor detecting positions of the salient poles, and
in the rotational balance measurement step,
the position of the unbalanced portion in the circumferential direction of the weight is specified based on a detection signal from the rotation detection sensor.

3. The rotational balance correction method according to claim 1, wherein the correction device comprises an end surface detection sensor detecting a position of an end surface on one side along an axial direction of the weight, and
in the rotational balance correction step,
a position of the cutting tool with respect to the axial direction of the weight is controlled based on a detection signal from the end surface detection sensor.

4. A rotational balance correction method for correcting rotational balance of a rotor,
wherein the rotor comprises:
a shaft;
a rotor core provided on the shaft;
a magnet provided on the rotor core; and
a weight provided on the shaft and arranged coaxially with the rotor core,
wherein a measuring device measuring rotational balance of the rotor, and a correction device correcting rotational balance of the rotor by cutting the weight are used,
wherein the measuring device executes a rotational balance measurement step of rotating the rotor, and in the case where there is an unbalanced portion with a mass M having a center of gravity at a position at a distance r from a rotation center of the rotor in a radial direction of the weight, seeking a balance correction amount B indicated by a product of the distance r and the mass M, and specifying a position of the unbalanced portion in a circumferential direction of the weight,
wherein the correction device executes a rotational balance correction step of using a calculation formula for obtaining a cutting depth R along the radial direction of the weight from the balance correction amount B to control a cutting tool so as to achieve the cutting depth R obtained by substituting the balance correction amount B into the calculation formula, and cutting the unbalanced portion of the weight, and
wherein in the case where the balance correction amount B is taken as x and the cutting depth R is taken as y, the calculation formula is indicated by:
a polynomial y=−5.5798x⁶+26.238x⁵−48.172x⁴+44.134x³−21.789x²+7.0366x+0.0796.

5. The rotational balance correction method according to claim 4, wherein the rotor core comprises a plurality of salient poles protruding radially outward,
the magnet is arranged between the salient poles adjacent to each other in a circumferential direction of the rotor core,
in an axial direction of the rotor, the plurality of salient poles protrude beyond the magnet,
the measuring device comprises a rotation detection sensor detecting positions of the salient poles, and
in the rotational balance measurement step,
the position of the unbalanced portion in the circumferential direction of the weight is specified based on a detection signal from the rotation detection sensor.

6. The rotational balance correction method according to claim 4, wherein the correction device comprises an end surface detection sensor detecting a position of an end surface on one side along an axial direction of the weight, and
in the rotational balance correction step,
a position of the cutting tool with respect to the axial direction of the weight is controlled based on a detection signal from the end surface detection sensor.
